(19) United States
(12) Patent Application Publication
(10) Pub. No.: US 2025/0201234 A1
(43) Pub. Date: Jun. 19, 2025

(54) SYSTEM FOR GENERATING CONVERSATIONAL CONTENT BY UTILIZING GENERATIVE AI AND METHOD THEREOF

(71) Applicants: HEMENDRA SINGH, ELLICOTT CITY, MD (US); ARUNA SINGH, ELLICOTT CITY, MD (US)

(72) Inventors: HEMENDRA SINGH, ELLICOTT CITY, MD (US); ARUNA SINGH, ELLICOTT CITY, MD (US)

(21) Appl. No.: 19/068,830

(22) Filed: Mar. 3, 2025

Related U.S. Application Data
(60) Provisional application No. 63/645,143, filed on May 10, 2024.

(51) Int. Cl. G10L 13/08; G06T 11/00; G06T 13/40

(52) U.S. Cl. CPC G10L 13/08; G06T 11/00; G06T 13/40; G06T 2211/441

(57) ABSTRACT

The invention discloses a system (100) for generating conversational content using a generative artificial intelligence (AI), said system (100) comprising: a user (101), an administrator (102), an application programming interface (API) server (103), a generative artificial intelligence (AI) server (104), a plurality of databases (105), a generative artificial intelligence (AI) processor (106), an audio generate processor (107), a text-to-speech processor/service provider (108), a video generation service (109), a video generation processor (110), and a memory communicatively coupled to the processor, wherein the memory stores processors instructions, which, on execution, causes the processor to generate at least one of conversational script, audio, video, or combination thereof. The system (100) allows users to create and customize various aspects of conversational content, including characters/personas/speakers, groups (of personas/characters/speakers), tones, content types, topics, conversation formats, and tone.

### CROSS REFERENCE TO RELATED APPLICATIONS

This application is a non-provisional application and claims the benefit under 35 U.S.C. 119 (e) of U.S. provisional application No. 63/645,143 filed on May 10, 2024 and hereby incorporated by reference in their entireties into this application.

### FEDERALLY SPONSORED RESEARCH AND DEVELOPMENT

Not applicable.

### MICROFICHE

Not applicable

### FIELD OF THE INVENTION

The present invention generally relates to the field of content creation. The invention, particularly relates to a system for generating conversational content. The invention more particularly relates to a system for generating digital conversational content by using generative artificial intelligence (AI). The present invention also discloses a method for generating conversational content by using generative artificial intelligence (AI). The conversational content can be either audio, video, and combination thereof.

### BACKGROUND OF THE INVENTION

Content creation is the contribution of information to any media and most especially to digital media for an end-user/audience in specific contexts. Content is “something that is to be expressed through some medium, as speech, writing or any of various arts” for self-expression, distribution, marketing and/or publication. Typical forms of content creation include maintaining and updating web sites, blogging, article writing, photography, videography, online commentary, the maintenance of social media accounts, and editing and distribution of digital media. Content Creation includes several stages starts from content planning, which further has several substeps such as researching on the content topics, defining the audience, finding relevant keywords, going thru various available databases; then next step is Creation Process what type of content and what final format will be of the content; and finally publishing or making desired final output.

Natural language generation (NLG) is a technology that allows computers to generate human-like language, acting as a translator of data to words. It converts structured information into cohesive sentences and paragraphs, enhancing communication. This helps make complex data more understandable for people.

A number of different types of methods and systems for generating content are available in prior art. For example, the following patents are provided for their supportive teachings and are all incorporated by reference: U.S. Pat. No. 10,649,988 discloses An artificial intelligence and machine learning infrastructure system, including: one or more storage systems comprising, respectively, one or more storage devices; and one or more graphical processing units, wherein the graphical processing units are configured to communicate with the one or more storage systems over a communication fabric; where the one or more storage systems, the one or more graphical processing units, and the communication fabric are implemented within a single chassis.

Another prior-art document, U.S. Pat. No. 11,562,146, discloses Artificial intelligence (AI) technology used in combination with composable communication goal statements to facilitate a user's ability to quickly structure story outlines in a manner usable by an NLG narrative generation system without any need for the user to directly author computer code. Narrative analytics that are linked to communication goal statements can employ a conditional outcome framework that allows the content and structure of resulting narratives to intelligently adapt as a function of the nature of the data under consideration. This AI technology permits NLG systems to determine the appropriate content for inclusion in a narrative story about a data set in a manner that will satisfy a desired communication goal. This prior-art does not appear to discuss the use of generative AI.

Yet another prior-art document, U.S. Pat. No. 10,551,993, a computer-implemented content development environment enabled creation of interactive characters and other digital assets for use in various types of 3D content. In this context, 3D content generally may refer to any type of content (e.g., short films, video games, educational content, simulations, etc.), including VR content that can be consumed by viewers using one or more types of VR devices. In many instances, 3D content may be generated using visualization and/or input mechanisms that rely on VR equipment, including one or more three dimensional, computer-generated environments (either real or fantastical) that a viewer can explore using VR devices in similar fashion to how the viewer might explore the real world. For example, a viewer may use a head-mounted display (HMD) device, various motion detecting devices, and/or other devices to simulate the experience of exploring a landscape. One or more different types of VR devices may be used to simulate various sensory experiences including sight, motion, touch, hearing, smell, etc. This prior-art mainly focuses only on Virtual Reality devices and does not appear to discuss the use of generative AI.

Yet another prior-art document discloses the generative AI contribution to creating tailored content-based websites, exploring the pros and cons of implementation while analyzing its implications on user satisfaction and commercial success. The methodology as they address data collection, preprocessing, model training, generation, and evaluation. The study findings reveal that generative AI can produce customized websites in accordance with users' choices and needs. Examining existing literature and case studies, this paper delves into the uses, drawbacks, and future possibilities of generative AI in personalized web development. The methodology as they address data collection, preprocessing, model training, generation, and evaluation. The study findings reveal that generative AI can produce customized websites in accordance with users' choices and needs (see: https://www.researchgate.net/publication/374192283_Role_of_Generative_Al_for_Developing_Personalized_Content_Based_Websites. This prior-art mainly focuses only on generating website and does not appear to discuss the frequently generation of various types of digital conversational content.

Yet another prior-art document, US20210224346, discloses a method includes receiving an indication of a trigger action by a first user at a client system, wherein the trigger action is associated with a priming content object, identifying related content objects associated with the priming content object, selecting recommended content objects based on the priming content object, the related content objects, and profile information of the first user, wherein each of the selected recommended content objects comprises entity information of entities associated with the priming content object, and presenting content suggestions at the client system, wherein each content suggestion comprises one of the selected recommended content objects. The prior-art does not appear to discuss the use of generative AI.

Yet another prior-art document, U.S. Pat. No. 11,163,777, discloses software tools and feature vector comparisons to analyze and recommend images, text content, and other relevant media content from a content repository. A digital content recommendation tool may communicate with a number of back-end services and content repositories to analyze text and/or visual input, extract keywords or topics from the input, classify and tag the input content, and store the classified/tagged content in one or more content repositories. Input text and/or input images may be converted into vectors within a multi-dimensional vector space, and compared to a plurality of feature vectors within a vector space to identify relevant content items within a content repository. Such comparisons may include exhaustive deep searches and/or efficient tag-based filtered searches. Relevant content items (e.g., images, audio and/or video clips, links to related articles, etc.), may be retrieved and presented to a content author and embedded within original authored content. The prior-art does not appear to discuss the use of generative AI.

The present application aims to address these concerns and shortcomings by proposing a system for generating digital conversational content by using a generative artificial intelligence (AI).

### SUMMARY OF THE INVENTION

In the view of the foregoing disadvantages inherent in the known types methods and systems for generating content now present in the prior art, the present invention provides a system for generating digital conversational content by using a generative artificial intelligence (AI). The general purpose of the present invention, which will be described subsequently in greater detail, is to provide an innovative and novel system and method for creating multimodal conversational content that combines text, audio, and video outputs.

The main objective of the present invention is to provide A system for generating multimodal content using a generative artificial intelligence (AI), said system comprising a user interface, wherein said user interface is configured to receive content generation parameters from a user, the parameters specifying generation of text, audio, and optionally video content; and present generated content to said user; a processing environment wherein said processing environment includes an application programming interface (API) server; a generative artificial intelligence (AI) server; a generative artificial intelligence (AI) processor; an audio generate processor; a text-to-speech processor/service provider; a video generation service; and a video generation processor; a storage system, wherein said storage system comprises a voice repository, metadata, user defined speakers and speaker groups, wherein said speaker groups comprises user defined speaker profiles and global speaker profiles with voice mappings and wherein said metadata comprises classification tags, audience discovery and filtering, a content categorization, multilingual content discovery, multilingual content indexing, and synchronization information, markers for content alignment, timing parameters, hierarchical linking of all content types, and parameters for multimodal synchronization; wherein said storage system is configured to store and support said structured content, intermediate outputs, final outputs, voice repositories comprising voice configurations and language mappings, speaker groups for multi-party content generation, classification tags, synchronization information, modular editing, content regeneration, and version control; wherein said processing environment is configured to generate a structured content based on content generation parameters, generate a synchronized audio content based on said structured content; and generate video content by synchronizing visual elements with said structured content and said synchronized audio content, wherein said structured content comprises a plurality of segments; wherein said components of the processing environment are communicatively coupled together, and execute instructions to generate at least one of conversational script, audio, video, or combination thereof through coordinated operation of said API server, generative AI server, generative AI processor, audio generate processor, text-to-speech processor, video generation service and video generation processor.

Another objective of the present invention is to provide a system for generating multimodal content using a generative artificial intelligence (AI), wherein said processing environment can be a centralized processing environment or a distributed processing environment.

Another objective of the present invention is to provide a system for generating multimodal content using generative artificial intelligence (AI), wherein said segments comprises audio content, video content, mandatory elements, speaker identifiers, textual elements, tone attributes, style attributes, gender attributes, and sound effect markers.

Another objective of the present invention is to provide a system for generating multimodal content using a generative artificial intelligence (AI), wherein said distributed processing environment is configured to support a distributed architecture in which structured content generation, audio content generation, and video content generation, when specified, are performed on distinct modules communicatively coupled via a network, a centralized architecture configured to process structured content, synchronized audio content, and, when specified, video content within a single processing module; and data and metadata are stored in said storage system for retrieval and reuse in subsequent tasks, enabling modular and iterative processing workflows.

Another objective of the present invention is to provide the system for generating multimodal content using a generative artificial intelligence (AI), wherein said distributed processing environment integrates fallback mechanisms to dynamically adjust said audio content generation and video content generation based on incomplete or missing parameters and errors in distributed processing modules.

Another objective of the present invention is to provide the system for generating multimodal content using a generative artificial intelligence (AI), wherein said voice repository comprises voice identifiers, text-to-speech service provider configurations, service-specific parameters; and supported language mappings.

Another objective of the present invention is to provide a system for generating multimodal content using a generative artificial intelligence (AI), wherein said content generation parameters comprise a content type selection, a topic, an optional specified language, a plurality of speaker identifiers, speaker group identifiers, complete speaker's profiles, tone attributes, style attributes, gender attributes, sound effect markers and content safety constraints.

Another objective of the present invention is to provide a system for generating multimodal content using a generative artificial intelligence (AI), wherein the system performs: receiving, by said API server, a plurality of attributes by said user through a web-based app or mobile-app, wherein said plurality of attributes comprises conversation type, topic, format, language, speaker ID or speakers group ID; generating, by said generative AI processor, conversational script based on said plurality of attributes and publish the message for audio generation on message queue, wherein said user can edit the script produced by said Generative AI processor in manual mode; generating, by said audio generate processor, audio content based generated conversational script; and generating, by said video generation service, the videos based on conversational script and the audio content.

Another objective of the present invention is to provide a method for generating multimodal content by a system, wherein said method comprises the following steps: Receiving, via a user interface or application programming interface (API), content generation parameters from a user; Dynamically retrieving or receiving, by a generative artificial intelligence (AI) processor, from one or more storage systems or as part of the content generation request a prompt template corresponding to the specified content type; Retrieving corresponding speaker profiles from said storage systems, wherein each speaker profile comprising descriptive information related to the speaker, including at least one of a name identifier, personality traits, behavioral characteristics, demographic attributes, and/or detailed description provided to tailor a conversational content; Extracting the descriptive information, when provided, from the input for tailoring the conversational content; Preparing, by the generative artificial intelligence (AI) processor, a complete prompt, wherein said complete prompt based on retrieved or provided said speaker profiles, said content generation parameters; and instructions specifying the format of a structured conversational script; Following any predefined instructions to enforce safety constraints and generating metadata; Transmitting, by the generative artificial intelligence (AI) processor, said completed prompt to an external generative artificial intelligence (AI) server, which is configured to generate said conversational content; Receiving, by the generative artificial intelligence (AI) processor, a response from the external generative artificial intelligence (AI) server; and Storing said structured conversational script and said metadata, wherein said metadata comprises classification tags, audience discovery and filtering, a content categorization, multilingual content discovery, multilingual content indexing, and synchronization information, markers for content alignment, timing parameters, hierarchical linking of all content types, and parameters for multimodal synchronization; Transmitting, by said system, said structured conversational script and said metadata to a processing environment; and Generating synchronized audio and/or video outputs.

Another objective of the present invention is to provide a method for generating multimodal content by the system, wherein said metadata is configured to support: hierarchical relationships linking said structured conversational script with audio content, video content, and/or associated media outputs with processing records; content management features including modular editing, segment regeneration and updates; version control, change tracking, contextual adjustments; content requirements including audience suitability requirements, regulatory, cultural constraints; content synchronization features including updates to specific segments of the script without regenerating the entire output; and re-synchronization of the updated segments with corresponding audio and, when specified, video outputs.

Another objective of the present invention is to provide a system for generating audio and video content, comprising a processing environment communicatively coupled to storage systems, wherein said processing environment comprises one or more processors; and one or more memory components storing instructions that, when executed by the processor, configure the system to: Retrieve, from said storage systems, a structured conversational script comprising text segments with speaker associations, Retrieve speaker profiles and voice mappings associated with the speakers; Retrieve voice repository configurations for text-to-speech processing; Generate audio content by resolving voice assignments for each speaker by retrieving voice mappings from speaker profiles and applying fallback voice selection when needed; Producing speech audio segments using text-to-speech processing; Integrating sound effects based on script markers; Combining a speech audio segments into a unified audio file; Generate video content by retrieving visual elements associated with speaker attributes, synchronizing the visual elements with the audio segments, and combining the synchronized elements into a unified video file; Store a generated content in the storage systems, wherein said generated content comprises said audio segments, said unified audio file, said video segments, said unified video files, Synchronizing metadata linking all said generated content; and wherein further said system supports Distributed processing across multiple machines connected via a network; Centralized processing within a single machine, and implements fault tolerance through automatic retry mechanisms, load distribution; and fallback processing options.

Another objective of the present invention is that the generating conversational script comprises: retrieving appropriate prompt templates from storage system based on specified conversation type; processing speaker information through: retrieving individual speaker profiles or speaker group profiles from storage, incorporating speaker-specific characteristics and parameters, applying relevant speaker constraints; generating conversation by: preparing final prompt by combining prompt template with retrieved speaker profiles and parameters, obtaining conversational script from generative AI server based on prepared prompt; processing and storing generated content wherein: conversational script is segmented into multiple parts, each segment comprises speaker identification, conversational text, and sound effect markers, and script is stored along with associated metadata in the data store

Another objective of the present invention is that generating audio based on conversational script comprises: processing the segmented conversational script wherein: system retrieves speaker voice configurations and settings for each segment based on speaker ID; generating audio content segments through converting text to speech for each script segment by calling TTS service based on voice settings, incorporating specified sound effects at marked positions; producing final audio output by: combining individual audio segments into unified audio content, applying timing synchronization between segments, storing the generated audio content with relevant metadata.

Another objective of the present invention is that generating video based on said conversational script and said audio comprises: preparing for video generation wherein: system retrieves the conversational script segments and corresponding audio content, accesses speaker-specific visual attributes and configurations; generating video content through: creating video segments for each conversation item, synchronizing visual elements with corresponding audio segments and applying specified visual effects and transitions; producing final video output by: combining individual video segments into unified content, ensuring proper synchronization between visual and audio elements, and storing the generated video content with associated metadata.

Another objective of the present invention is that the user has access to the web-based app or mobile-app to communicate with the system by using an object device.

Another objective of the present invention is that the object device comprises a server, a desktop, a laptop, a notebook, a netbook, a tablet, a smartphone, a mobile phone, or any other computing device.

Another objective of the present invention is that the system can be configured for different users and give user options to generate only conversational text content, and from conversational text content audio file, and from audio file generate video file for better user customization and experience.

Another objective of the present invention is that the system allows users to create and customize various aspects of conversational content, including speakers (aka persona), speakers groups (aka persona groups), tones, content types, topics, and conversation formats.

### BRIEF DESCRIPTION OF THE DRAWINGS

The invention will be better understood and objects other than those set forth above will become apparent when consideration is achieved to the following detailed description thereof. Such a description makes reference to the annexed drawings wherein:

FIG. 1 depicts a schematic flow chart of a system of generating conversational content in accordance with the present invention.

FIG. 2 depicts a schematic flow chart of a method of generating conversational content with Auto Mode in accordance with the present invention.

FIG. 3 depicts a schematic flow chart of a method of generating conversational script only in accordance with the present invention.

FIG. 4 depicts a schematic flow chart of a method of generating conversational audio content in accordance with the present invention.

FIG. 5 depicts a schematic flow chart of a method of generating conversational video content in accordance with the present invention.

FIG. 6 depicts a schematic diagram of user interface of a system of generating conversational content in accordance with the present invention.

FIG. 7 depicts a diagram of user interface of creating a group of persona/character in accordance with the present invention.

FIG. 8 depicts a schematic diagram of a user interface for creating content request with a group in accordance with the present invention.

FIG. 9 depicts a schematic diagram of a user interface for creating content request with a single persona in accordance with the present invention.

FIG. 10 depicts a schematic diagram of a user interface for generating the digital content in accordance with the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized, and that structural and logical changes may be made without departing from the spirit and scope of the present invention. The following detailed description is, therefore, not to be taken in a limiting sense.

The present invention is described in brief with reference to the accompanying drawings. Now, refer in more detail to the exemplary drawings for the purposes of illustrating non-limiting embodiments of the present invention.

As used herein, the term “comprising” and its derivatives including “comprises” and “comprise” include each of the stated integers or elements but does not exclude the inclusion of one or more further integers or elements.

As used herein, the singular forms “a”, “an”, and “the” include plural referents unless the context clearly dictates otherwise. For example, reference to “a device” encompasses a single device as well as two or more devices, and the like.

As used herein, the terms “for example”, “like”, “such as”, or “including” are meant to introduce examples that further clarify more general subject matter. Unless otherwise specified, these examples are provided only as an aid for understanding the applications illustrated in the present disclosure, and are not meant to be limiting in any fashion.

As used herein, the terms “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition and persons in the pertinent art have given that term as reflected in printed publications and issued patents at the time of filing.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

There is an ever-growing need in the art for improved natural language generation (NLG) technology that harnesses computers to process data sets and automatically generate narrative stories about those data sets. NLG is a subfield of artificial intelligence (AI) concerned with technology that produces language as output on the basis of some input information or structure, in the cases of most interest here, where that input constitutes data about some situation to be analyzed and expressed in natural language. Many NLG systems are known in the art that use template approaches to translate data into text. However, such conventional designs typically suffer from a variety of shortcomings such as constraints on how many data-driven ideas can be communicated per sentence, constraints on variability in word choice, and limited capabilities of analyzing data sets to determine the content that should be presented to a reader.

Generative AI sets itself apart from traditional AI by the fact that it is capable of generating new content such as visuals, audio and textual data. It may seem like technology has only recently emerged. However, this is not entirely true. The first generative algorithms date back to the origins of AI as a field of computer science. Machine learning, neural networks, and deep learning have become more widely accessible and have given new opportunities to develop smarter and responsive systems. Deep learning has been growing particularly fast in the 2010s. It is a type of machine learning that employs multi-layered neural networks that self-train on a large dataset.one of the first primitive generative AI was ELIZA. It was a text chat bot created in the 1960s by Joseph Weizenbaum. ELIZA was one of the first examples of Natural Language Processing (NLP) and mimicked the work of a psychotherapist and could communicate with humans in natural language.

Generative AI is a type of AI that can create realistic images and videos, generate text or music. To achieve this, generative AI models are applied. The purpose of such models is to generate new samples from what was already in the training data. Some of the first generative models were Hidden Markov Models (HMMs) and Gaussian Mixture Models (GMMs) that were devised in the 1950s. They produced successive pieces of data, such as speech. For instance, for HMMs, one of the first applications was speech recognition. The productivity of generative models, though, significantly boosted only after the rise of deep learning. In the field of natural language processing, recurrent neural networks (RNNs), which were introduced in the late 1980s, are used for language modeling tasks. RNNs can model relatively long dependencies and allow generating longer sentences. Long Short-Term Memory (LSTM), a kind of recurrent neural network, was later developed. One of the fundamental breakthroughs in generative AI is the creation of Generative Adversarial Networks (GANs) in 2014 by an American computer scientist Ian Goodfellow. It is an unsupervised machine learning algorithm that engages two neural networks that are in competition with each other. One network is a generative model that generates content and the other is discriminative that tries to figure out whether it is an authentic sample or not.

Traditional methods of creating conversational content often rely on human writers or voice actors, which can be resource-intensive and may not always produce the desired results and limit the creativity of content creator. Therefore, there is a need for a system and method that can efficiently generate high-quality digital conversational content which includes scripts and audio files, while providing users with the ability to define and customize various parameters, such as characters, personas, content types, tones, and conversation formats, to meet their specific needs and provide authentic experience.

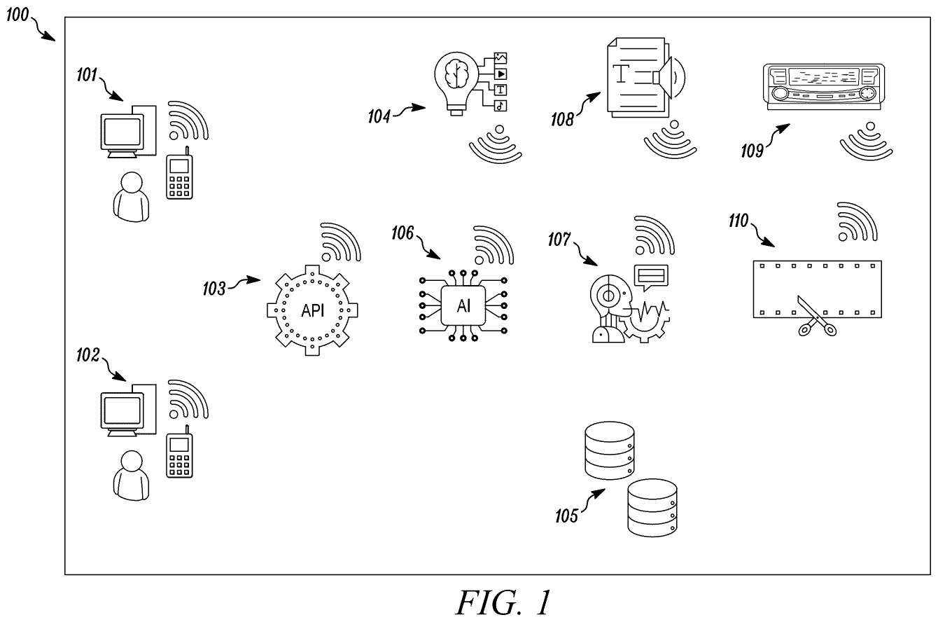

The present invention relates to a system for generating digital content by using generative artificial intelligence. FIG. 1 depicts a schematic flow chart of the system (100) for generating conversational content in accordance with the present invention. The system (100) comprises a user interface (not shown) for accessing the system by a user (101) or an administrator (102); a processing environment that includes processing components-an application programming interface (API) server (103) implementing protocols like RESRful,; a generative artificial intelligence server (104), a plurality of storage systems (105), a generative artificial intelligence processor (106), an audio generate processor (107), and a text-to-speech processor/service provider (108) and a video generation service (109). The system is accessible through web-based app or mobile-app, enabling user (101) and administrator (102) to interact with the system by using an object device. The object device can be personal computer, laptop, smart phone, tablet, kiosk, or any type of hand-held device.

The storage system comprises data repository including voice repository containing voice configurations, user created speaker profiles with voice mappings, global speaker profiles with default voice mapping, user created speaker groups for multi party conversations, structured conversational contents, intermediate and final outputs (conversation scripts/audio/videos) and the metadata. The metadata are generated or created during the processing or working of the system, comprises classification tags, audience discovery and filtering, a content categorization, multilingual content discovery, multilingual content indexing, and synchronization information, markers for content alignment, timing parameters, hierarchical linking of all content types, and parameters for multimodal synchronization. The processing environment can be a centralized processing environment or a distributed processing environment. The storage system communicatively coupled to the processing environment (centralized or distributed) The storage system and processing environment is also configured to support version control for structured content, synchronized audio content, and, when generated, video content; and enable rollback or iterative refinement of generated outputs.

The distributed processing environment supports: a distributed architecture in which structured content generation, audio content generation, and video content generation, when specified, are performed on distinct modules communicatively coupled via a network, which may be distributed across multiple physical machines or implemented as logically distinct modules within a single machine; a centralized architecture configured to process structured content, synchronized audio content, and, when specified, video content within a single processing module; and further the intermediate results are stored in the storage system for retrieval and reuse in subsequent tasks, enabling modular and iterative processing workflows.

The distributed processing environment integrates fallback mechanisms to dynamically adjust audio content generation and, when specified, video content generation based on incomplete or missing user parameters; or errors in distributed processing modules. The voice repository in the storage system comprises: voice identifiers; text-to-speech service provider configurations; service-specific parameters; and supported language mappings.

The metadata is maintained to support content discovery through: classification tags optimized for audience targeting; content categorization for filtering; multilingual content indexing. Further content synchronization, from the metadata, is also executed through: alignment markers for multimodal content; timing parameters for audio-video synchronization. Moreover the metadata and storage system also stores the content relationships through: hierarchical linking of all content types; speaker profile associations; version tracking; modular editing through: segment-level access; regeneration capabilities; and change management.

The storage system maintains speaker profiles including the following activities such as user-defined speakers with custom voice mappings that override any matching global speakers, global speakers (voice assignments are persistently stored for reuse across content generations) serving as system-wide defaults used only when user-defined speakers are not available; and global speaker profiles are dynamically created when no matching profile exists, ensuring fallback voice mapping for text-to-speech (TTS) generation.

The speaker groups in the storage system supports multi-party conversation generation including debates, interviews and dialogues etc; group-specific attributes including predefined roles; and also helps in storing persistently information such as group configurations; speaker-voice relationships; and conversation role assignments.

The processing environment interacts with the stored speaker profiles by: retrieving voice mappings for identified speakers; retrieving stored voice configurations to call TTS service to generate audio segments. In case when no matching profile exists then creating new global speaker profiles, assigning fallback voices based on speaker attributes in conversational script; and storing the assignments for future use.

The processing environment also has function or capable of assigning fallback voices by: retrieving available voice configurations from the voice repository; selecting fallback voices; and storing the assigned fallback voices as global speaker profiles for consistent reuse. The fallback voices are selected based on default voice settings configured for the system; gender attributes in the conversational content; language requirements of the content; and random assignment from compatible voices.

A method for generating conversational content in the system is also disclosed. The method comprising the following steps: Receiving, via a user interface or application programming interface (API), content generation parameters from a user; Dynamically retrieving or receiving, by a generative artificial intelligence (AI) processor, from one or more storage systems or as part of the content generation request a prompt template corresponding to the specified content type; Retrieving corresponding speaker profiles from the storage systems, each speaker profile comprising descriptive information related to the speaker; Extracting the descriptive information from the input for tailoring the conversational content; Preparing, by the generative artificial intelligence (AI) processor, a completed prompt including instructions to into multiple segments based on predefined criteria; and Formatting rules for structuring and synchronizing content, which may include embedding markers for applying segment-level sound effects, where markers can encompass text-based, visual, contextual, or other elements; and transmitting, by the generative artificial intelligence (AI) processor, the completed prompt to an external generative artificial intelligence (AI) server configured to generate conversational content; Receiving, by the generative artificial intelligence (AI) processor, a response from the external generative artificial intelligence (AI) server, the response (which includes a structured conversational script and associated metadata); and storing, in the storage system, the structured conversational script; and the associated metadata linking the script to downstream audio, video, and other generated outputs; Transmitting, by the system, the structured conversational script and metadata to processing components, either distributed across a network or operating within a single machine; for further generation of synchronized audio and, when specified, video outputs.

The parameters, received from the user, may include the parameters including: a content type selection; a topic; an optional specified language; one or more of speaker identifiers, speaker group identifiers, or complete speakers profiles; optional tone or format specifications; and optional content safety constraints. The completed PROMPT is based on the retrieved or provided speaker profiles; the content generation parameters; and instructions specifying the format of the structured conversational script. Further, the structured conversational script comprising at least segment-level attributes, including at least mandatory attributes such as speaker identification and text content, and optionally, attributes such as gender and sound effect markers, when specified or configured.

The metadata are configured to hierarchical relationships linking said structured conversational script with audio content, video content, and/or associated media outputs, processing records, modular editing, segment regeneration and updates; version control, change tracking, contextual adjustments, content generation parameters, audience suitability requirements, regulatory, cultural constraints, updates to specific segments of the script without regenerating the entire output; and re-synchronization of the updated segments with corresponding audio and, when specified, video outputs.

Another embodiment of the system is also disclosed. The system for generating audio and video content, comprising a processing environment communicatively coupled to storage system (which includes one or more processors; and one or more memory components storing instructions that, when executed by the processor). The system of the present invention is configure to: Retrieve from the storage systems a structured conversational script comprising text segments with speaker associations; Speaker profiles and voice mappings associated with the speakers; Voice repository configurations for text-to-speech processing; Generate audio content by resolving voice assignments for each speaker by retrieving voice mappings from speaker profiles; Applying fallback voice selection when needed; Producing speech audio segments using text-to-speech processing; Integrating sound effects based on script markers; combining the speech audio segments into a unified audio file; Generate video content, when specified; Store in the storage systems information such as the generated audio segments; the unified audio file; moreover when video is generated then the video segments and the unified video file; and finally synchronization metadata linking all generated content.

The video content is generated by retrieving visual elements associated with speaker attributes; synchronizing the visual elements with the audio segments; and combining the synchronized elements into a unified video file.

The system of the present invention also supports: distributed processing across multiple machines connected via a network; and/or centralized processing within a single machine; and implements fault tolerance. The fault tolerance is implemented through automatic retry mechanisms; load distribution; and fallback processing options.

The generating audio content by the system and method of the present invention includes the following steps: utilizing voice mappings according to a hierarchy of user-defined speaker profiles, global speaker profiles and fallback voice assignments; dynamically integrating sound effects based on explicit sound effect markers; or contextual cues from the script; and finally maintaining consistent voice assignments across content generations.

The generating video content by the system and method of the present invention includes the following steps: generating video content includes: Retrieving visual elements, which includes the following attributes speaker-specific avatars, animations, static images, background media assets, when specified, or default background assets when configured, text overlays derived from the script; Applying fallback visual elements when specified elements are not found, by using default speaker representations based on speaker attributes; Selecting alternative background assets; or generating placeholder visual elements; synchronizing visual transitions with audio segment boundaries; and integrating user-specified background video when provided.

The generative artificial intelligence processor (106) of the system of the present invention is configured to process or execute the following actions: (i) Create a AI prompt with content generation request parameters; (ii) Send the prompt request to the generative artificial intelligence server (104); generative artificial intelligence server returns the conversation script based on prompt request;

(iii) Process generative artificial intelligence server response and arrange the response in structured data (conversation script); (iv) Save the response and prompt request in the database; and (v) Send a audio creation request to Audio Generate Processor (107). The audio generate processor (107) is configured to process or execute the following actions: (i) Process the audio request, get the conversations in sequence from the conversation script; (ii) Identify each conversation element (speaker, text) and lookup mapped the voice for the speaker; (iii) Send the request to TTS service to generate audio for this conversational element and save it to audio file (segment audio file); (iv) retrieve sound effects audio files based on sound effect markers from the conversation elements; (iv) Combine all the audio files (segments) and sound effects generated into one file; and (v) Save the final audio file into the storage device including cloud so that user can save, share or download the final audio file.

The video generation processor (110) configured to process or execute the following actions for a conversational script for which audio segments are generated: (i) for each conversation and its segment audio file, lookup the visual elements including any pictures associated with the speaker and the visual elements with audio segment and create a video segment file by sending audio segment, visual elements, text of conversation element to the video generation service (109); (ii) The video generation service (109) generate a video segment file for the script segment and return the video segment to the video generation processor (110) (iii) (iv) the video generation processor (110) combining all the video files (segments) generate one single file; and if specified apply the background image to the video file (v) save the final file. (start of new paragraph here) The above steps are shown when system is configured to generate all digital contents (text, audio, video) in automatic mode; however system can be configured for different user and give user option to generate only conversational text content, and from conversational text content audio file, and from audio file generate video file for better user experience. The present invention allows users to create and customize various aspects of conversational content, including speaker (for single-party conversation) speaker group (for multiparty conversation), tones, content types, topics, conversation formats, and tone.

The present invention enables user to create and manage speaker and speaker groups (for multiparty conversations). User can customize or assign various attributes to the speakers including name, gender, age, personality traits, occupation/expertise or characteristics along with a mapped voice from voice repository. User can further create different speakers groups and assign different speakers along with their role (e.g. host, member etc.) for multiparty conversations. The present invention also discloses a method for generating conversational

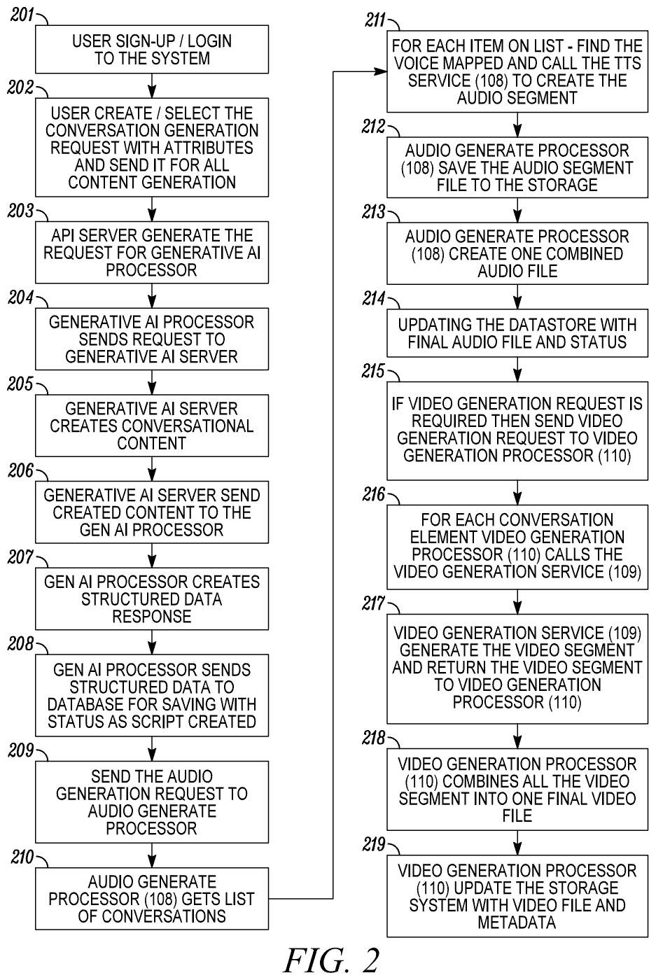

content by using generative artificial intelligence (AI). FIG. 2 depicts a schematic flow chart of a method of generating conversational content in accordance with the present invention. The generation of conversational digital content starts when the user (101) having access to the web-based app or mobile-app to communicate sign-up or log-in to the system of the present invention (step 201) using an object device.

In the next step 202, user create or select content generation request with attributes like conversation content type, conversation topic, conversation format, tone along with speaker or speaker group; utilizing the user interface provided and invoke the API server (103) to start the content generation process. User has option to specify in the request to generate conversational script, final audio content and video content all at once (auto mode) or combinations of the contents (manual mode).

In the step 203, API server (103) generates the request for the generative artificial intelligence processor (106) to start the conversational script generation process. the generative artificial intelligence processor (106) save the request along with all the parameters and create a prompt by first locating the corresponding prompt template for the content type, process the template and inject it with the request parameters and sends all information to the generative artificial intelligence server (104) (step 204). In the next step 205 the generative artificial intelligence server (104) simulate the conversation based on prompt request and create the conversational content. In the next step 206 the generative artificial intelligence server (104) sends created conversational content to the generative artificial intelligence processor. The generative artificial intelligence processor (106) processes the response to create a conversational script in structured data (conversation script that contains list of conversations) along with metadata from the response (step 207). In the next step 208, the generative artificial intelligence processor (106) saves the conversation script along with metadata into the storage system (105) for storing purpose.

In the next step 209, if the request is in auto mode the generative artificial intelligence processor (106) prepares and send the audio generation request to audio generate processor (107). In the next step 210, the Audio generate processor (107) gets list of conversations from the conversational script in sequence. Each list item contains the speaker, text and sound effect markers. In the step 211, the Audio generate processor for each conversation element (each conversation element contains speaker, text and sound effect markers) identify the voice mapped based on speaker or if the mapping is not found it then pick a voice from the global default speakers list from storage or create a global speaker with a voice for later lookup. The audio generate processor send the request to Text-to-speech (TTS) service (108) to generate audio for this conversational element (segment) with text and voice identifier. Text-to-speech processor (108) sends back the converted audio file to the audio generate processor (107). In step 212, the audio generate processor (107) save it to audio file (segment audio file), update the conversational element in storage system with audio file location and with metadata about the processing. In the next step 213, the audio generate processor (107) combines all the audio files (segments) and sound effect markers to generate one final audio file with its location. The audio generate processor (107) saves all the files (segment audio files, and final combined audio file) and store them into the storage system along with updated metadata information (step 214).

The audio generate processor (107) checks whether any video content need to be generated (auto mode) and if needed the audio generate processor (107) prepare and send the video generation request to the Video generation processor (110) (step 215). In the next step 216, the Video generation processor (110) gets list of conversations from the conversation script with audio segment files. Each conversation list item contains the speaker and audio segment file location and from the storage system lookup the visual items associated with speaker of the segment, and background visual items and calls the video generation service (109) to generate the video segment file passing the text for the segment, visual items, and audio segment. In the next step 217 the video generation service (109) generate the video segment file utilizing AI technologies and multimedia technologies and return the segment video files along with any metadata generated, In the next step 218 video generation processor combine all video segments into one final synchronized video file. In the next step 219 video generation processor (110) update the storage system with all the video outputs (segment and final combined videos) and metadata.

The present invention also has many more advantages and can also be incorporated more alternative embodiments. The system can also allow creating multiple speakers (personas). Further these speakers can be grouped together to simulate conversations, such as but not limited to multi-party dialogues,, interviews etc. The present allows users to assign voices to the created speakers, providing a more immersive and personalized experience. The present invention provides users with the ability to select types of content, such as but not limited to memes, standup comedy, educational, storytelling, philosophical, interviews, sports, entertainment, informational, travel, reviews, opinions, and others. The system will maintain a list of content types that can be modified by a system administrator. The present invention enables users to select the tone of the conversation, such as, but not limited to, sarcastic, humorous, ironic, wholesome, inspirational, or deadpan, from a predefined configurable list that can be modified by a system administrator. The present invention enables the users to select the format of the conversation, such as but not limited to-setup/punchline, multi-part jokes, overly literal explanations, dialogues, and others, from a configurable list maintained in the system. The invention maintains a mapping of content types to suitable conversational tones and conversation formats to assist users in selecting appropriate combinations for their desired content. Users can further provide a topic description during the selection of content type, tones, and formats, to guide the content generation process. Based on the user input and selections, the first step for the system is for generative AI model to generate the conversational content in text format. In the second step the generated text content is processed by text-to-speech agents to produce audio files, as per user customization utilizing all the parameters and assigned voices to the speakers providing a seamless and immersive digital conversational content generation. In the third step the generated text and audio content is processed by video generation service (109) and video generation processors (110) to produce video files, as per user customization utilizing visual items (including pictures or videos) assigned to speakers. The present invention offers a comprehensive and flexible solution for generating high-quality digital conversational content tailored to specific user requirements, while streamlining the content creation process and invoke creative thinking and innovation. Digital Conversational content (Text, Audio and Video) is created in multiple Languages including all major spoken languages including English, French, Spanish, Hindi etc.

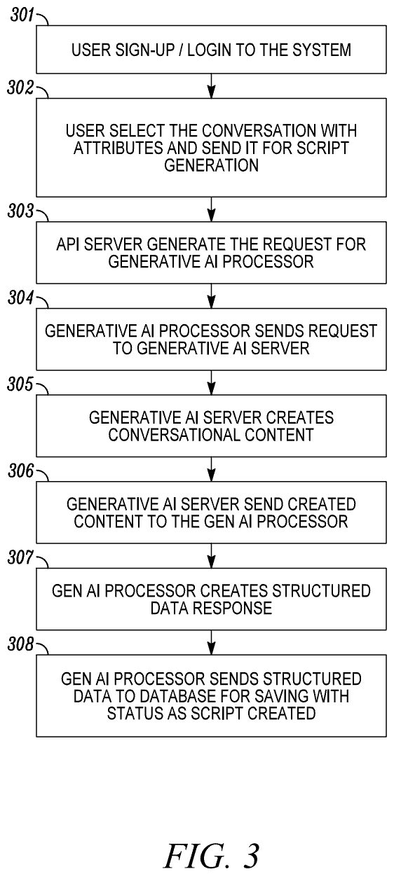

The system also has provision and is configured to generate customized requests such as generating only Conversation Script. FIG. 3 depicts a schematic flow chart of a method of generating conversational script only in accordance with the present invention. The process begins when the User Sign-Up or Login to the system (step 301). The User create or select the conversation with attributes and send it for script generation. The attributes can be related to the content type, topic, language, tone, format, etc., including speaker or speaker group (step 302). In the next step 303, the API server (103) receives the request from the user (101) and API server (103) generates the request format for the generative artificial intelligence processor (106). The generative artificial intelligence processor (106) create a prompt with filled in parameters (content generation parameters) utilizing the prompt template mapped to content type and send request to the generative artificial intelligence Server (104) (step 304) for creating conversational script content. In the next step 305, the generative artificial intelligence Server (104) creates script conversational content. The generative artificial intelligence Server (104) returns created script content to the generative artificial intelligence processor (step 306). The generative artificial intelligence processor creates structured conversational script with list of conversations (step 307). The generative artificial intelligence processor store the conversational content to database with metadata and status as script created (step 308).

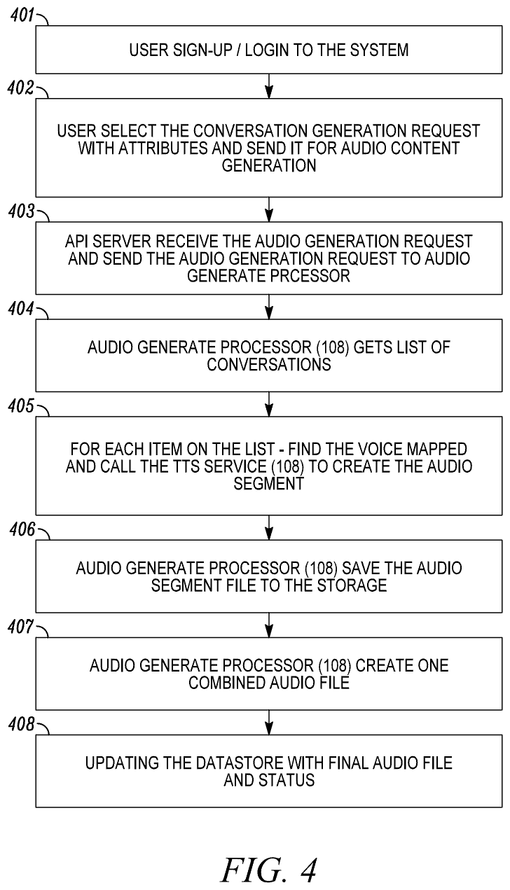

The system also has provision and is configured to generate customized requests such as generating only Audio Conversation Content. FIG. 4 depicts a schematic flow chart of a method of generating conversational audio content in accordance with the present invention. The process begins when the User Sign-Up or Login to the system (step 401). In the next step 402, User Select the conversation with script created status (conversation script already generated by the system as explained in the FIG. 3 or can be uploaded by the user) and send it for audio generation. The conversation script already generated by contains a list of conversations with speakers, text and sound effect markers in the next step 403 API server (103) generate the request for audio generate processor (108) to start the audio generation process. Audio generate processor (107) gets the list of conversations from the conversational script (step 404). In the step 405 the Audio generate processor for each conversation element (each conversation element contains speaker, text and sound effect markers) identify the voice mapped based on speaker or if the mapping is not found it then pick a voice from the global default speakers list from storage or create a global speaker with a voice for later lookup. The audio generate processor send the request to Text-to-speech (TTS) service (108) to generate audio for this conversational element (segment) with text and voice identifier. Text-to-speech processor (108) sends back the converted audio file to the audio generate processor (107). In step 406 the audio generate processor (107) save it to audio file (segment audio file), update the conversational element in storage system with audio file location and with metadata about the processing. In the next step 407, the audio generate processor (107) combines all the audio files (segments) and sound effect markers to generate one final audio file. In the next step 408 the audio generate processor (107) saves all the files (segment audio files, and final combined audio file) and store them into the storage system along with updated metadata information.

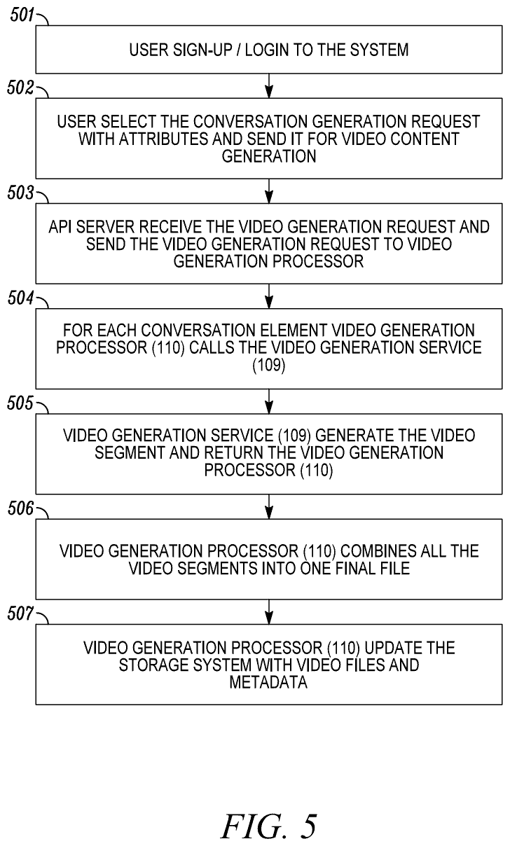

The system also has provision and is configured to generate customized requests such as generating Video Conversation Content. FIG. 5 depicts a schematic flow chart of a method of generating conversational video content in accordance with the present invention. The process begins when the User Sign-Up or Login to the system (step 501). In the next step 502, User select the conversation with script and audio created status (conversation script and audios already generated by the system) and send it for video generation. In the next step 503 API server receives the request for video generation and send the video generation request to the video generation processor (110). In the next step 504, the video generation processor (110) gets the list of conversations with audio segment files from the conversation script. Each conversation list item contains the speaker and audio segment file location. the video generation processor (110) lookup the speaker visual items and background visual items from the storage system and calls the video generation service (109) to generate the video segment file passing the text for the segment, visual items, and audio segment. In the next step 505 the video generation service (109) generate the video segment file utilizing AI technologies and multimedia technologies and returns the segment video files along with any metadata generated. In the next step 506 video generation processor combine all video segments into one final synchronized video file. In the next step 507 video generation processor (110) update the storage system with all the video outputs (segment and final combined videos) and metadata.

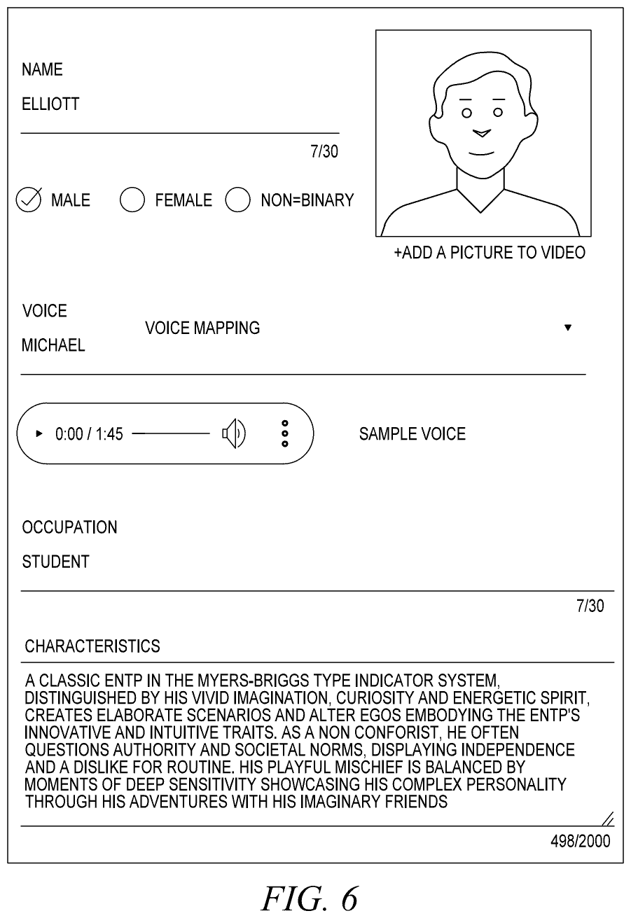

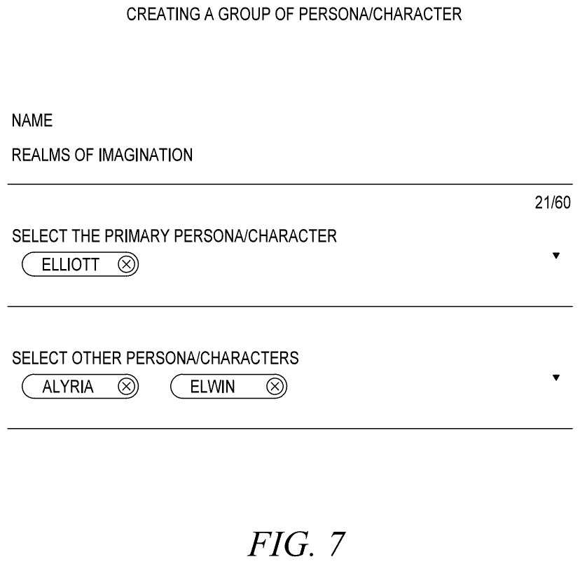

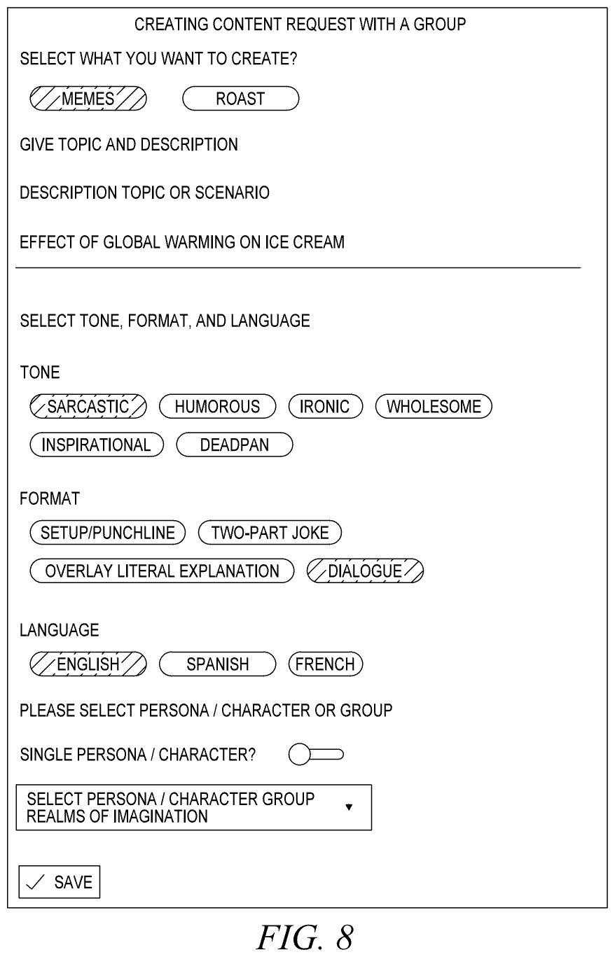

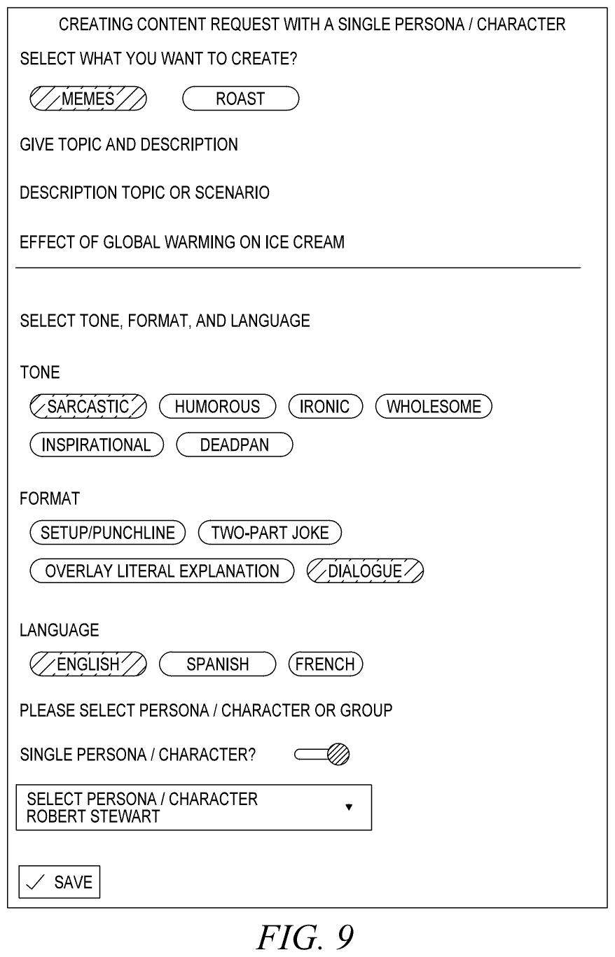

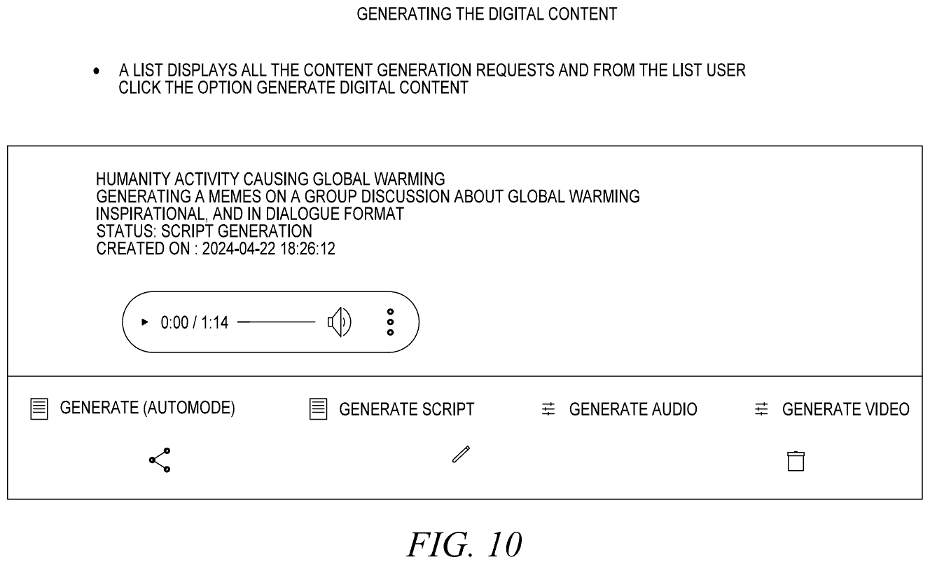

User interface of the system of the present invention is represented in FIGS. 6 to 10. FIG. 6 depicts a schematic diagram of user interface of a system of Speaker (Persona) creation for generating conversational content in accordance with the present invention. FIG. 7 depicts a diagram of user interface of creating a group of Speakers (persona) in accordance with the present invention. FIG. 8 depicts a schematic diagram of a user interface for creating content request with a speaker group in accordance with the present invention. FIG. 9 depicts a schematic diagram of a user interface for creating content request with a single speaker (persona) in accordance with the present invention. FIG. 10 depicts a schematic diagram of a user interface for generating the digital content in accordance with the present invention.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention

have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

We claim:

1. A system for generating multimodal content, comprising:
a user interface configured to:
receive content generation parameters from a user, the parameters specifying generation of text, audio, and optionally video content; and
present generated content to the user;
a processing environment, including:
one or more processors; and
one or more memory components storing instructions that, when executed by the one or more processors, cause the system to:
generate structured content based on the content generation parameters, the structured content comprising one or more segments;
generate synchronized audio content based on the structured content; and
optionally generate video content by synchronizing visual elements with the structured content and the synchronized audio content; and
a storage system communicatively coupled to the distributed processing environment, configured to:
store:
structured content, intermediate outputs, and final outputs;
a voice repository comprising voice configurations and language mappings;
user-defined and global speaker profiles with voice mappings;
speaker groups for multi-party content generation;
maintain metadata including:
classification tags supporting:
audience discovery and filtering;
content categorization;
multilingual content discovery;
synchronization information comprising:
markers for content alignment;
parameters for multimodal synchronization;
hierarchical relationships linking:
structured content;
synchronized audio content;
video content, when generated;
speaker profiles with voice mappings;
processing records enabling:
modular editing;
content regeneration;
version control;
support modular editing, synchronization, and discoverability of the generated content.

2. The system in accordance to claim 1, wherein each segment of the structured content includes:
mandatory elements:
speaker identifiers; and
textual content; and
optional elements, including one or more of:
tone or style attributes;
gender attributes;
sound effect markers embedded within the textual content; and
a segment-end sound effect marker specifying a sound effect to be injected at the end of the segment.

3. The system in accordance to claim 1, wherein the storage system is configured to:
support version control for structured content, synchronized audio content, and, when generated, video content; and
enable rollback or iterative refinement of generated outputs.

4. The system in accordance to claim 1, wherein the distributed processing environment supports:
a distributed architecture in which structured content generation, audio content generation, and video content generation, when specified, are performed on distinct modules communicatively coupled via a network, which may be distributed across multiple physical machines or implemented as logically distinct modules within a single machine;
a centralized architecture configured to process structured content, synchronized audio content, and, when specified, video content within a single processing module; and
intermediate results are stored in the storage system for retrieval and reuse in subsequent tasks, enabling modular and iterative processing workflows.

5. The system in accordance to claim 1, wherein the metadata is maintained to support:
content discovery through:
classification tags optimized for audience targeting;
content categorization for filtering;
multilingual content indexing;
content synchronization through:
alignment markers for multimodal content;
timing parameters for audio-video synchronization;
content relationships through:
hierarchical linking of all content types;
speaker profile associations;
version tracking;
modular editing through:
segment-level access;
regeneration capabilities;
change management.

6. The system in accordance to claim 1, wherein the distributed processing environment integrates fallback mechanisms to dynamically adjust audio content generation and, when specified, video content generation based on:
incomplete or missing user parameters; or
errors in distributed processing modules.

7. The system in accordance to claim 1, wherein the voice repository in the storage system comprises:
voice identifiers;
text-to-speech service provider configurations;
service-specific parameters; and
supported language mappings.

8. The system in accordance to claim 1, wherein the storage system maintains speaker profiles including:
user-defined speakers with custom voice mappings that override any matching global speakers;
global speakers serving as system-wide defaults used only when user-defined speakers are not available;
wherein for global speakers:
voice assignments are persistently stored for reuse across content generations;
speaker profiles are dynamically created when no matching profile exists, ensuring fallback voice mapping for text-to-speech (TTS) generation.

9. The system in accordance to claim 1, wherein speaker groups in the storage system support:
multi-party conversation generation including debates and dialogues;
group-specific attributes including predefined roles;
persistent storage of:
group configurations;
speaker-voice relationships;
conversation role assignments.

10. The system in accordance to claim 1, wherein the processing environment interacts with the stored speaker profiles by:
retrieving voice mappings for identified speakers;
applying stored voice configurations;
when no matching profile exists:
creating new global speaker profiles;
assigning fallback voices based on speaker attributes;
storing the assignments for future use.

11. The system in accordance to claim 10, wherein the processing environment assigns fallback voices by:
retrieving available voice configurations from the voice repository;
selecting fallback voices based on at least one of:
default voice settings configured for the system;
gender attributes specified in the content;
language requirements of the content;
random assignment from compatible voices;
storing the assigned fallback voices as global speaker profiles for consistent reuse.

12. A method for generating conversational content in a system, the method comprising:
receiving, via a user interface or application programming interface (API), content generation parameters from a user, the parameters including:
a content type selection;
a topic;
an optional specified language;
one or more of: speaker identifiers, speaker group identifiers, or complete speakers profiles;
optional tone or format specifications; and
optional content safety constraints;
dynamically retrieving or receiving, by a generative artificial intelligence (AI) processor, from one or more storage systems or as part of the content generation request:
a prompt template corresponding to the specified content type;
and, when speaker identifiers or speaker group identifiers are provided:
retrieving corresponding speaker profiles from the storage systems, each speaker profile comprising descriptive information related to the speaker, including at least one of:
a name identifier;
personality traits;
behavioral characteristics;
demographic attributes; or
any other high-level or detailed description provided to tailor the conversational content;
and, when complete speaker profiles are provided directly as input:
extracting the descriptive information from the input for tailoring the conversational content;
preparing, by the generative artificial intelligence (AI) processor, a completed prompt based on:
the retrieved or provided speaker profiles;
the content generation parameters; and
instructions specifying the format of the structured conversational script, comprising at least:
segment-level attributes, including at least mandatory attributes such as speaker identification and text content, and optionally, attributes such as gender and sound effect markers, when specified or configured;
requirements for dividing the script into multiple segments based on predefined criteria; and
formatting rules for structuring and synchronizing content, which may include embedding markers or applying segment-level sound effects, where markers can encompass text-based, visual, contextual, or other elements; and optionally, predefined instructions to enforce safety constraints and generate metadata;
transmitting, by the generative artificial intelligence (AI) processor, the completed prompt to an external generative artificial intelligence (AI) server configured to generate conversational content;
receiving, by the generative artificial intelligence (AI) processor, a response from the external generative artificial intelligence (AI) server, the response including:
a structured conversational script and associated metadata;
storing, in the storage system:
the structured conversational script; and
the associated metadata linking the script to downstream audio, video, and other generated outputs;
transmitting, by the system, the structured conversational script and metadata to processing components, either distributed across a network or operating within a single machine;
for further generation of synchronized audio and, when specified, video outputs.

13. The method in accordance to claim 12, wherein the completed prompt transmitted to the external generative artificial intelligence (AI) server includes:
mandatory elements, including:
content type, defining the genre of the content;
topic, specifying the subject matter description; and
speaker attributes, including at least one of: gender, personality traits, behavioral characteristics, or demographic attributes; and
optional elements, such as format, tone specifications, and content safety constraints, when specified in the content generation parameters;
the content safety constraints are configured to dynamically:
filter prohibited or sensitive content;
enforce compliance with predefined safety rules; and
adapt to target audience needs, regulatory standards, or other contextual parameters based on the content generation parameters;
all configured to guide the external server in generating the structured conversational script in a manner that ensures the generated content is safe and compliant.

14. The method in accordance to claim 12, wherein the metadata includes:
classification tags generated by the external generative artificial intelligence (AI) server supporting:
audience discovery and filtering;
content categorization;
multilingual content discovery;
content compliance validation;
synchronization information comprising:
markers for content alignment;
parameters for multimodal synchronization;
segment boundaries and transitions;
hierarchical relationships linking:
structured conversational script;
audio content;
video content;
associated media outputs;
processing records enabling:
modular editing;
segment regeneration and updates;
version control;
change tracking;
contextual adjustments based on:
content generation parameters;
audience suitability requirements;
regulatory and cultural constraints.

15. The method in accordance to claim 12, wherein the system supports distributed processing by:
coordinating with remote processing components to generate audio outputs and, when specified, video outputs based on the structured conversational script; and
utilizing distributed storage systems to store metadata linking the generated outputs to the original structured conversational script.

16. The method in accordance to claim 12, wherein the structured conversational script and metadata are configured to support modular editing, enabling:
updates to specific segments of the script without regenerating the entire output; and
re-synchronization of the updated segments with corresponding audio and, when specified, video outputs.

17. A system for generating audio and video content, comprising:
a processing environment communicatively coupled to storage system, comprising:
one or more processors; and
one or more memory components storing instructions that, when executed by the processor, configure the system to:
retrieve from the storage systems:
a structured conversational script comprising text segments with speaker associations;
speaker profiles and voice mappings associated with the speakers;
voice repository configurations for text-to-speech processing;
generate audio content by:
resolving voice assignments for each speaker by:
retrieving voice mappings from speaker profiles;
applying fallback voice selection when needed;
producing speech audio segments using text-to-speech processing;
integrating sound effects based on script markers;
combining the speech audio segments into a unified audio file;
generate video content, when specified, by:
retrieving visual elements associated with speaker attributes;
synchronizing the visual elements with the audio segments;
combining the synchronized elements into a unified video file;
store in the storage systems:
the generated audio segments;
the unified audio file;
when video is generated:
the video segments;
the unified video file;
synchronization metadata linking all generated content;
wherein the system supports:
distributed processing across multiple machines connected via a network; and
centralized processing within a single machine;
and implements fault tolerance through:
automatic retry mechanisms;
load distribution; and
fallback processing options.

18. The system in accordance to claim 17, wherein generating audio content includes:
utilizing voice mappings according to a hierarchy of:
user-defined speaker profiles;
global speaker profiles;
fallback voice assignments;
dynamically integrating sound effects based on:
explicit sound effect markers; or
contextual cues from the script; and
maintaining consistent voice assignments across content generations.

19. The system in accordance to claim 17, wherein generating video content includes:
retrieving visual elements comprising:
speaker-specific avatars, animations, or static images;
background media assets, when specified, or default background assets when configured;
text overlays derived from the script;
applying fallback visual elements when specified elements are not found, by:
using default speaker representations based on speaker attributes;
selecting alternative background assets; or
generating placeholder visual elements;
synchronizing visual transitions with audio segment boundaries; and
integrating user-specified background video when provided.

20. The system in accordance to claim 17, wherein the metadata includes:
classification tags supporting:
audience discovery and filtering;
content categorization;
multilingual content discovery;
synchronization information comprising:
markers for content alignment;
parameters for multimodal synchronization;
timing parameters for audio-video transitions;
hierarchical relationships linking:
text segments;
audio segments;
video segments;
unified output files;
processing records enabling:
modular editing;
segment regeneration and updates;
version control;
backup and recovery.
